(19) United States
(12) Patent Application Publication
(10) Pub. No.: US 2010/0225964 A1
(43) Pub. Date: Sep. 9, 2010

(54) IMAGE FORMING SYSTEM FOR PERFORMING PRINT PROCESSING ACCORDING TO APPROPRIATE TIMING

(75) Inventor: Kunio FURUKAWA, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/711,486

(22) Filed: Feb. 24, 2010

(30) Foreign Application Priority Data
Mar. 6, 2009 (JP) 2009-053287

(51) Int. Cl. G06F 15/00

(52) U.S. Cl. 358/1.15

(57) ABSTRACT

In a PC connected to an image forming apparatus, an image formation assist program starts at power-on (S101). Print modes are set in advance. In a mode for collectively performing printing when an application having produced print jobs ends, an accepted print instruction provided by an user's operation and the like is temporarily accumulated (S109), and the print jobs produced by the application will be collectively transmitted to the image forming apparatus (S115) when the ending of the application is sensed. In a mode for collectively performing the printing when all the applications end, all the accumulated print jobs are transmitted to the image forming apparatus (S119) when the ending of all the applications is sensed.

This application is based on Japanese Patent Application No. 2009-053287 filed with the Japan Patent Office on Mar. 6, 2009, the entire content of which is hereby incorporated by reference.

### BACKGROUND OF THE INVENTION

1. Field of the Invention

The present invention relates to an image forming system, an information processing device, a print server, an image forming apparatus, a medium recording an image formation assist program and a print control method. Particularly, the invention relates to an image forming system, an information processing device, a print server, an image forming apparatus, a medium recording an image formation assist program and a print control method for performing printing after temporarily accumulating a print job.

2. Description of the Related Art

Image forming apparatuses such as a printer, a copy machine and a MFP (Multi-Function Peripheral) that is a combination of them must perform a preparation operation such as potential formation on a photosensitive member at start of image formation processing.

When the image formation processing ends, an end operation such as potential resetting of the photosensitive member must be performed. Therefore, when printing of a small number of pages is performed many times by a conventional image forming apparatus that performs the image formation every time the print instruction is issued, the numbers of the preparation operations and the end operations increase, and a drive time of an image forming unit becomes long. This results in increase in electric power consumption and deterioration of a life of the image forming unit of the photosensitive member and the like.

For overcoming the above problem, Japanese Laid-Open Patent Publication No. 10-095146 has disclosed an image forming apparatus provided with a storage device such as a hard disk drive. This image forming apparatus temporarily accumulates a required print job in a storage device without immediately executing it. When predetermined conditions such as arrival at a predetermined time or increase of accumulated data to a predetermined quantity are satisfied, the apparatus returns from sleep and performs the print processing collectively for accumulated print jobs.

However, a system using the image forming apparatus disclosed in Japanese Laid-Open Patent Publication No. 10-095146 does not immediately perform the print processing in response to the user's print instruction in some cases, and the user cannot immediately obtain a required printout in such cases. Conversely, when a user is browsing the Web or is executing an application, the user may instruct the printing every time a page to be printed is displayed, but will continue the web browsing or application execution. In this case, the user does not require the printout immediately after the print instruction, and the printing may be performed by collectively performing the print processing after the end of the browsing or the execution.

For dealing with the above case, Japanese Laid-Open Patent Publication No. 10-095146 has disclosed a method in which the apparatus can accept an instruction for immediately performing the print processing together with the print instruction, and immediately performs the print processing without waiting for the predetermined conditions described above when it receives the above instruction. This method can perform the print processing for the respective print jobs according to appropriate timing.

However, whenever the user instructs the printing, the user is required to determine whether the print processing is to be performed immediately or not. When the print processing is to be performed immediately, the user must perform an instruction input operation for such immediate printing in addition to the conventional operation of the print processing. This complicates the user's operations. Further, increase of the operations causes a higher possibility of misoperation.

### SUMMARY OF THE INVENTION

The invention has been made in view of the above problems, and an object of the invention it to provide an image forming system, an information processing device, a print server, an image forming apparatus, a medium bearing an image formation assist program and a print control method that perform print processing for a print job according to appropriate timing without requiring complicated operations.

For achieving the above object, according to an aspect of the invention, an image forming system, for performing print processing in an image forming apparatus based on an operation in an information processing device, includes a producing unit for producing a print job based on an operation in the information processing device; a storing unit for storing the print job in a storage device; a sensing unit for sensing ending of an application in the information processing device; and a print processing unit for performing print processing in the image forming apparatus for the print job stored in the storing unit when the sensing unit senses the ending of the application.

Preferably, the information processing device includes the producing unit, the storing unit and the sensing unit, and the information processing device further includes a transmitting unit for reading the print job stored in the storage device and transmitting the print job to the image forming apparatus when the sensing unit senses the ending of the application. The image forming apparatus includes the print processing unit, and the image forming apparatus further includes a receiving unit for receiving the print job transmitted from the information processing device. The print processing unit executes the print processing for the print job when the receiving unit receives the print job from the information processing device.

Further preferably, the storing unit stores the print job in the storage device with a link established to the application used for producing the print job, and when the sensing unit senses the ending, in the information processing device, of the application used for producing the print job, the print processing unit executes the print processing for the print job stored in the storage device with the link established to the application.

Further preferably, when the sensing unit senses the ending, in the information processing device, of all the applications capable of producing the print jobs, the print processing unit executes the print processing for all the print jobs stored in the storage device.

Further preferably, the information processing device further includes a selection unit for selecting a print mode to be executed from among first, second, and third print modes. The first print mode is for immediately starting the print processing in response to the print job indicated by the print instruction. The second print mode is for executing the print processing for the print job stored in the storage device with a link established to the application when the ending of the application used for producing the print job is sensed. The third print mode is for executing the print processing for all the print jobs stored in the storage device when the ending of all the applications capable of producing the print jobs is sensed. The transmitting unit transmits the print job to the image forming apparatus according to the timing of the print processing defined in the selected print mode.

Preferably, the information processing device includes the producing unit and the sensing unit, and the information processing device further includes a first transmitting unit for transmitting the produced print job to the image forming apparatus, and a second transmitting unit for transmitting, to the image forming apparatus, information to the effect that the sensing unit sensed the ending of the application. The image forming apparatus includes the storing unit and the print processing unit, and the image forming apparatus further includes a first receiving unit for receiving the print job transmitted from the information processing device and a second receiving unit for receiving the information transmitted from the information processing device and indicating that the information processing device sensed the ending of the application. The storing unit stores the print job received by the first receiving unit in the storage device; and the print processing unit executes the print processing for the print job when the second receiving unit receives, from the information processing device, the information to the effect that the ending of the application was sensed.

Further preferably, the storing unit stores the print job in the storage device with a link established to the application used for producing the print job, and when the second receiving unit receives the information to the effect that the ending of the application used for producing the print job is sensed, the print processing unit executes the print processing for the print job stored in the storage device with the link established to the application.

Further preferably, the storing unit further stores the print job in the storage device with a link established to the information processing device.

Preferably, when the second receiving unit receives the information indicating that the ending of all the applications capable of producing the print jobs was sensed, the print processing unit executes the print processing for all the print jobs stored in the storage device.

Preferably, the image forming apparatus further includes a selection unit for selecting a print mode to be executed from among first, second, and third print modes. The first print mode is for immediately starting the print processing in response to the print job indicated by the print instruction. The second print mode is for executing the print processing for the print job stored in the storage device with a link established to the application when the ending of the application used for producing the print job is sensed. The third print mode is for executing the print processing for all the print jobs stored in the storage device when the ending of all the applications capable of producing the print jobs is sensed. The print processing unit executes the print processing for the print job according to the timing of the print processing defined in the selected print mode.

According to another aspect of the invention, an information processing device being communicably connectable to an image forming apparatus includes a storage device and a processor. The processor is configured i) to produce a print job by an application, ii) to store the print job in the storage device, iii) to sense ending of the application, and iv) to read the print job stored in the storage device and providing a print instruction for the print job to the image forming apparatus when the ending of the application is sensed.

Preferably, when storing the print job in the storage device, the processor stores the print job with a link established to the application. When providing the print instruction, the processor reads the stored print job linked to the application from the storage device and provides the print instruction for the print job to the image forming apparatus when the ending of the application used for producing the print job is sensed in the processing of sensing the ending of the application.

Preferably, when the ending of all the applications capable of producing the print jobs is sensed in the processing of sensing the ending of the application, the processor performs the processing of outputting the print instruction by reading all the print jobs stored in the storage device and providing the print instruction for the print jobs to the image forming apparatus.

Preferably, the information processing device further includes an input device for accepting input of an instruction for selecting a print mode to be executed from among first, second, and third print modes. The first print mode is for immediately starting the print processing in response to the print job indicated by the print instruction. The second print mode is for executing the print processing for the print job stored in the storage device with a link established to the application when the ending of the application used for producing the print job is sensed. The third print mode is for executing the print processing for all the print jobs stored in the storage device when the ending of all the applications capable of producing the print jobs is sensed. When providing the print instruction, the processor provides the print instruction for the print job to the image forming apparatus according to the timing of the print processing defined in the selected print mode.

According to further another aspect of the invention, a print server includes a communication device for connection to an information processing device and an image forming apparatus capable of producing a print job by an application, and a processor. The processor is configured i) to sense ending of the application in the information processing device, and ii) to provide a print instruction for the print job produced by the application to the image forming apparatus when the ending of the application is sensed.

Preferably, the print server further includes a storage device for storing the print job with a link established to the application used for producing the print job and the information processing device. When the ending of the application in the information processing device is sensed, the processor performs the processing of providing the print instruction by reading the stored print job linked to the application and the information processing device from the storage device and providing the print instruction for the print job to the image forming apparatus.

Preferably, the print server further includes a storage device for storing the print job with a link established to the information processing device. When the ending of all the applications cable of producing the print job is sensed in the information processing device, the processor performs the processing of providing the print instruction by reading all the print jobs stored in the storage device with the link established to the application and providing the print instruction for the print jobs to the image forming apparatus.

Preferably, the print server further includes a storage device for storing the print job with a link established to the information processing device. When the ending of the application is sensed in the information processing device, the processor performs the processing of providing the print instruction by reading the print job stored in the storage device with the link established to the information processing device and providing the print instruction for the print job to the image forming apparatus.

Preferably, the print server further includes an input device for accepting input of an instruction for selecting a print mode to be executed from among first, second, and third print modes. The first print mode is for immediately starting the print processing in response to the print job indicated by the print instruction. The second print mode is for executing the print processing for the print job stored in the storage device with a link established to the application when the ending of the application used for producing the print job is sensed. The third print mode for executing the print processing for all the print jobs stored in the storage device when the ending of all the applications capable of producing the print jobs is sensed. In the processing of providing the print instruction, the processor provides the print instruction for the print job to the image forming apparatus according to the timing of the print processing defined in the selected print mode.

According to further another aspect of the invention, an image forming apparatus includes a receiving unit for receiving a print job produced by an application from an information processing device; a storing unit for storing the print job in a storage device; a sensing unit for sensing ending of the application in the information processing device; and a print processing unit for reading the print job stored in the storage device and executing print processing when the sensing unit senses the ending of the application.

Preferably, the storing unit stores the print job in the storage device with a link established to the application used for producing the print job, and the print processing unit executes the print processing by reading the stored print job linked to the application form the storage device when the sensing unit senses the ending, in the information processing device, of the application used for producing the print job.

Further preferably, the storing unit further stores the print job in the storage device with a link established to the information processing device.

Preferably, the print processing unit executes the print processing for all the print jobs stored in the storage device when the sensing unit senses the ending, in the information processing device, of all the applications capable of producing the print jobs.

Preferably, the image forming apparatus further includes a selection unit for selecting a print mode to be executed from among first, second, and third print modes. The first print mode is for immediately starting the print processing in response to the print job indicated by the print instruction. The second print mode is for executing the print processing for the print job stored in the storage device with a link established to the application when the ending of the application used for producing the print job is sensed. The third print mode is for executing the print processing for all the print jobs stored in the storage device when the ending of all the applications capable of producing the print jobs is sensed. The print processing unit executes the print processing for the print job according to the timing of the print processing defined in the selected print mode.

According to further another aspect of the invention, a computer-readable medium records an image formation assist program for causing a computer to execute processing of printing, by an image forming apparatus, a print job produced in an information processing device. The program causes the computer to execute the steps of sensing ending of the application having produced the print job, obtaining the print job stored in the storage device based on the sensing of the ending of the application, and instructing the image forming apparatus to print the obtained print job.

According to further another aspect of the invention, a print control method for controlling printing by an image forming apparatus for a print job produced in an information processing device includes the steps of sensing ending of the application having produced the print job, obtaining the print job stored in the storage device based on the sensing of the ending of the application, and instructing the image forming apparatus to print the obtained print job.

The foregoing and other objects, features, aspects and advantages of the present invention will become more apparent from the following detailed description of the present invention when taken in conjunction with the accompanying drawings.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a structure of an image forming system including an image forming apparatus according to an embodiment.

FIG. 2 is a block diagram showing a specific example of a hardware structure of the image forming apparatus according to the embodiment.

FIG. 3 is a block diagram showing a specific example of a hardware structure of a PC according to a first embodiment included in the image forming system.

FIG. 4 is a block diagram showing a specific example of a functional structure of the PC according to the first embodiment.

FIG. 5 shows a specific example of a screen for setting a print mode.

FIG. 6 shows a specific example of information stored in the PC according to the first embodiment.

FIG. 7 is a flowchart showing a specific example of a flow of processing in the PC according to the first embodiment.

FIG. 8 is a block diagram showing a specific example of a functional structure of a PC according to a second embodiment.

FIG. 9 is a block diagram showing a specific example of a functional structure of an image forming apparatus according to the second embodiment.

FIG. 10 shows a specific example of information stored in the image forming apparatus according to the second embodiment.

FIG. 11 is a flowchart showing a specific example of a flow of processing in the PC according to the second embodiment.

FIG. 12 is a flowchart showing a specific example of a flow of processing in the image forming apparatus according to the second embodiment.

FIG. 13 shows a specific example of information stored in a print server according to a modification of the second embodiment.

### DESCRIPTION OF THE PREFERRED EMBODIMENTS

Embodiments of the invention will now be described with reference to the drawings. In the following description, the same parts and components bear the same reference numbers and the same names, and achieve the same functions. Therefore, description thereof is not repeated.

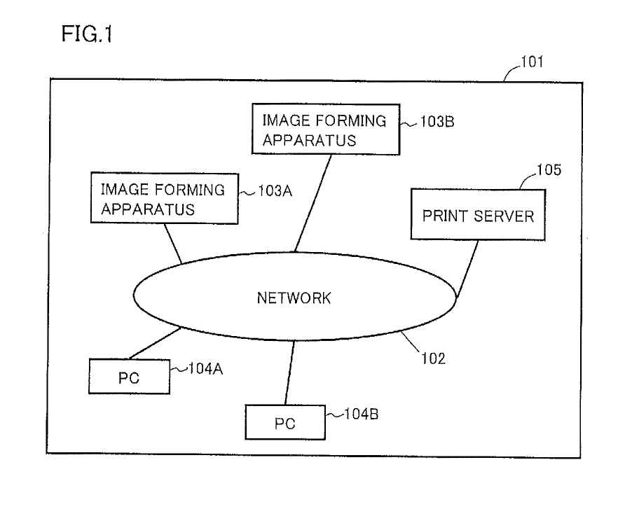

Referring to FIG. 1, an image forming system 101 according to an embodiment includes image forming apparatuses 103A and 103B that are connected to a network 102 (and will be representatively refereed to as “image forming apparatuses 103” hereinafter), and personal computers 104A and 104B which are information processing devices, respectively, and will be representatively referred to as “PCs 104” hereinafter. Network 102 may be formed of a public telephone line such as the Internet or may be formed of a dedicated line such as a LAN (Local Area Network). It is not restricted to the network for wire communications, and may be configured to perform wireless communications using, e.g., infrared rays.

PC 104 produces a print job for text data or image data by application software, and transmits the print job as well as an instruction signal instructing print processing for the print job to image forming apparatus 103 over network 102. Therefore, PC 104 can be considered as a control device of image forming apparatus 103. In addition to PC 104, image forming apparatus 103 itself may produce the print job. According to the above instruction, image forming apparatus 103 performs the print processing according to predetermined timing for the print job transmitted from PC 104 or the print job produced by image forming apparatus 103 itself.

In the embodiment, PC 104 transmits the print job to image forming apparatus 103 over network 102, and image forming apparatus 103 executes the print processing according to the predetermined timing as described above. In another form, image forming system 101 may include a print server 105 as shown in FIG. 1. When image forming system 101 includes print server 105, PC 104 transmits the print job to print server 105, which performs predetermined processing and then transmits it together with the print instruction to image forming apparatus 103 according to predetermined timing for performing the print processing. In this case, print server 105 can be considered as the control device of image forming apparatus 103.

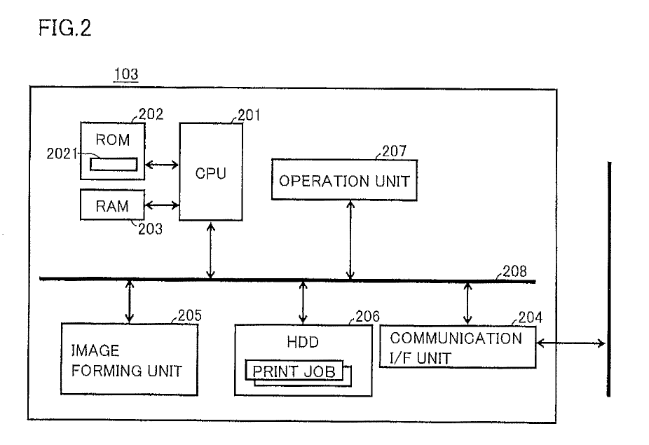

Referring to FIG. 2, image forming apparatus 103 includes a Central Processing Unit (which will be simply referred to as a “CPU) 201 entirely controlling image forming apparatus 103, a ROM (Read Only Memory) 202 that is a storage device for storing programs to be executed by CPU 201 and others, a RAM (Random Access Memory) 203 that is a storage device providing a storage area for another kind of information as well as a work area used for program execution, a communication interface (which will be simply referred to as a “I/F” hereinafter) unit 204 connecting image forming apparatus 103 to communication network 102 for performing bidirectional communications, an image forming unit 205, a hard disk drive (which will be simply referred to as an “HDD” hereinafter) 206 that is a storage device for storing print jobs for image data and others, and an operation unit 207 including an operation panel and operation keys that function as a user interface. A bus 208 connects them together.

PC 104 enters the print job through communication I/F unit 204. Also, CPU 201 produces the print job according to the operation signal provided from operation unit 207. HDD 206 stores the entered or produced print jobs in its predetermined area.

Image forming unit 205 is, e.g., a digital color printer of a tandem type. It may be a copying machine, a facsimile machine or an MFP (Multi Function Peripheral) that is a combination thereof. Also, the printing type is not restricted to the tandem type, and is not restricted to the digital type. A monochrome machine may be employed instead of the color machine.

### First Embodiment

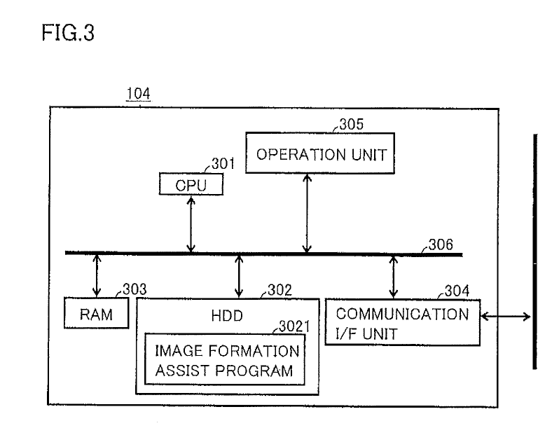

PC 104 may be a general personal computer. The hardware structure of PC 104 shown in FIG. 3 is the same as that of a general personal computer. Referring to FIG. 3, PC 104 includes a CPU 301 entirely controlling PC 104, an HDD 302 that is a storage device storing a control program to be executed by CPU 301 as will be described later and others, a RAM 303 that is a storage device storing other information and providing a work area for executing the program, a communication I/F unit 304 that connects PC 104 to communication network 102 for bidirectional communications, and an operation unit 305 that is formed of a keyboard and a mouse for entering instructions by operating them. A bus 306 connects them together. In the first embodiment, as shown in FIG. 3, FWD 302 has stored an image formation assist program 3021.

CPU 301 reads and executes image formation assist program 3021 and programs such as an application and a printer driver (not shown) that are stored in HDD 302 for controlling image forming apparatus 103. Thereby, CPU 301 produces a print job according to an operation signal provided from operation unit 305, and provides it to image forming apparatus 103 through communication I/F unit 304 together with a print instruction according to predetermined timing.

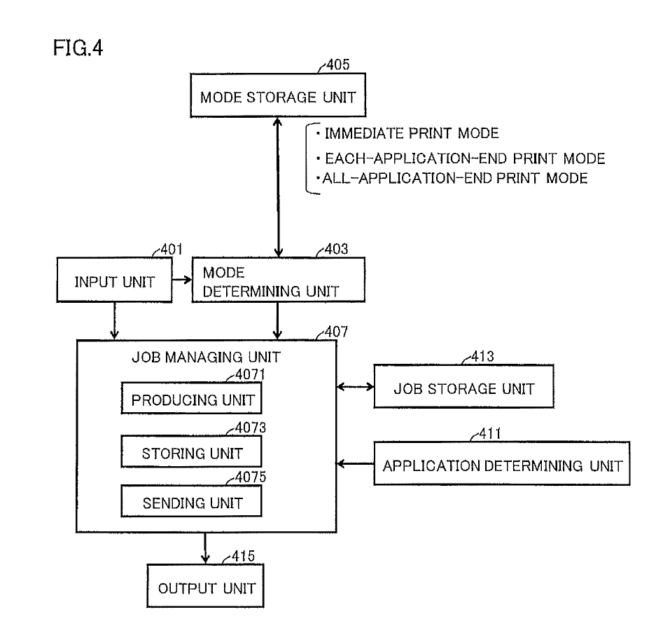

CPU 301 primarily implements the function of PC 104 shown in FIG. 4 by reading image formation assist program 3021 stored in HDD 302 and executes it as a memory-resident program. A part of such function may be a function formed in CPU 301. Also, a part of such function may be formed of a hardware structure.

Referring to FIG. 4, the above function of PC 104 includes an input unit 401, a first determining unit 403, a first storage unit 405, a managing unit 407, a second determining unit 411, a second storage unit 413 and an output unit 415.

For producing the print job, operation unit 305 accepts a print operation according to the application executed by CPU 301. According to the application, the print instruction is produced based on the operation signal provided from operation unit 305, and is provided to CPU 301 together with information indicating a storage location of data to be printed. This storage location may be set in another storage device that is included in image forming system 101 (not shown in FIG. 1) or is present outside image forming system 101. Also, the storage location may be a predetermined area in HDD 302 or RAM 303 of PC 104, or may be a predetermined area in HDD 206 of image forming apparatus 103. Further, it may be present in any storage device that can make communications with image forming apparatus 103.

Input unit 401 accepts the above print instruction provided from the application, and provides this print instruction to first determining unit 403 and managing unit 407. First storage unit 405 has stored the print modes that are already set. When first determining unit 403 receives the print instruction, it specifically determines the print mode that is set, and provides information indicating the set mode to managing unit 407.

The print mode specifies a relationship between the print instruction and the timing for starting the print processing. Specific print modes are as follows. A first print mode is an “immediate print mode”, a second print mode is “each-application-end print mode”, and a third print mode is “all-application-end print mode”. The first print mode specifies that the instructed print processing for a document is executed immediately when the print instruction is provided. The second print mode specifies that the print processing is executed in response to the ending of the application that is the output source of the print instruction for the print job. The third print mode specifies that the print processing will be executed in response to the ending of all the applications that are being executed by PC 104 when the print instruction for the print job is performed. “All the applications” may not be completely all the applications, and are the applications such as a word processing application, a spreadsheet application and a web browsing application that can produce at least the print data. Accordingly, the third print mode can be considered to specify that the print processing is to be executed when the state of execution of the applications enters the state in which the user no longer instruct the printing and, in other words, when an operation system is still operating but PC 104 ends all applications such as the word processing application, spreadsheet application, web browsing application and the like that were being executed on the operation system and can produce the print instruction.

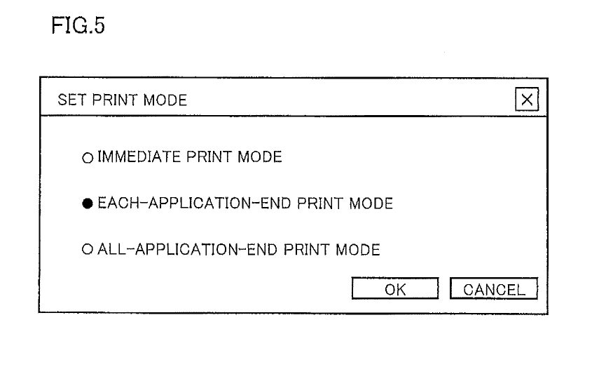

The print mode can be set according to predetermined timing. For example, the predetermined timing may be determined to match with the timing according to which CPU 301 starts the execution of the image formation assist program. Also, it may match with the timing according to which a predetermined operation is performed during the execution of the image formation assist program. For example, the print mode is set in the following method. Screen contents shown in FIG. 5 are displayed on a display unit (not shown) according to the above timing, and CPU 301 performs the setting based on the operation signal according to an operation that is performed according to the screen contents through operation unit 207, and writes the setting in first storage unit 405. As shown in FIG. 5, the initial setting of the print mode is preferably the “each-application-end print mode” that is the second print mode. Thereby, even when the user did not perform the setting operation, it is possible to ensure both the user's convenience and suppression of the power consumption in image forming apparatus 103 so that the above setting is preferable.

Second determining unit 411 monitors a function of CPU 301 for controlling the execution of the application (not shown), and thereby specifies the currently running application so that second determining unit 411 determines whether the application, i.e., the output source of the above print instruction has ended or not, and/or whether the execution of all the applications has ended or not, and provides a result of the determination to managing unit 407.

Managing unit 407 includes a producing unit 4071, a storing unit 4073 and a sending unit 4075. Producing unit 4071 produces the print job in cooperation with the function of the application for producing the print job according to the print instruction provided through input unit 401 from the application. The above function of producing the print job of the application may include a part of the function of producing unit 4071.

When first determining unit 403 determines that the current mode does not immediately execute the print processing in response to the print instruction, and thus is the foregoing second print mode, i.e., “each-application-end print mode” or the foregoing third print mode “all-application-end print mode”, managing unit 407 determines that the timing for performing the print processing for the print job is different from the timing of production of the print job. In this case, storing unit 4073 performs the processing of storing the produced print job in second storage unit 413 with a link established to the information specifying the application that is the output source of the print instruction.

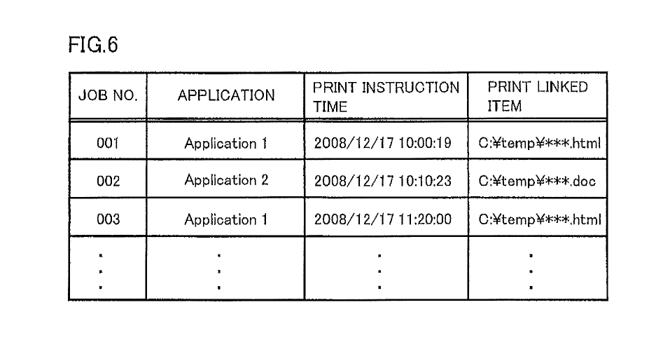

Referring to FIG. 6, storing unit 4073 determines the relationship or linkage for the print job according to the database including the information (application) specifying the application that is the output source of the print instruction, time information (print instruction time) about the time when the print instruction is issued and information (print linked item) indicating the storage location of the print target data. Thereby, storing unit 4073 assigns the number to the print job, and stores it in second storage unit 413. In the above example, the application that is the output source of the print instruction provides the information indicating the storage location of the data. However, the application may be configured to provide the data itself In this case, second storage unit 413 may store the data of the print target data linked to the print job.

When first determining unit 403 determines that the current mode immediately executes the print processing in response to the print instruction, and thus is the foregoing first print mode, i.e., “immediate print mode”, managing unit 407 determines that the current timing is configured to execute the print processing in response to the print job. In this case, sending unit 4075 transmits the produced print job to output unit 415.

When first determining unit 403 determines that the foregoing second print mode, i.e., “each-application-end print mode” is set, managing unit 407 determines that the current timing is configured to execute the print processing for the stored print job linked to the ended application. In this case, sending unit 4075 reads the stored print job linked to the application, and transmits it to output unit 415.

When first determining unit 403 determines that the foregoing third print mode, i.e., “all-application-end print mode” is set, managing unit 407 determines that the current timing is configured to execute the print processing for all the print jobs stored in second storage unit 413. In this case, sending unit 4075 reads all the print jobs stored in second storage unit 413, and transmits it to output unit 415.

Output unit 415 performs the processing of outputting the print job through communication I/F unit 304 to image forming apparatus 103.

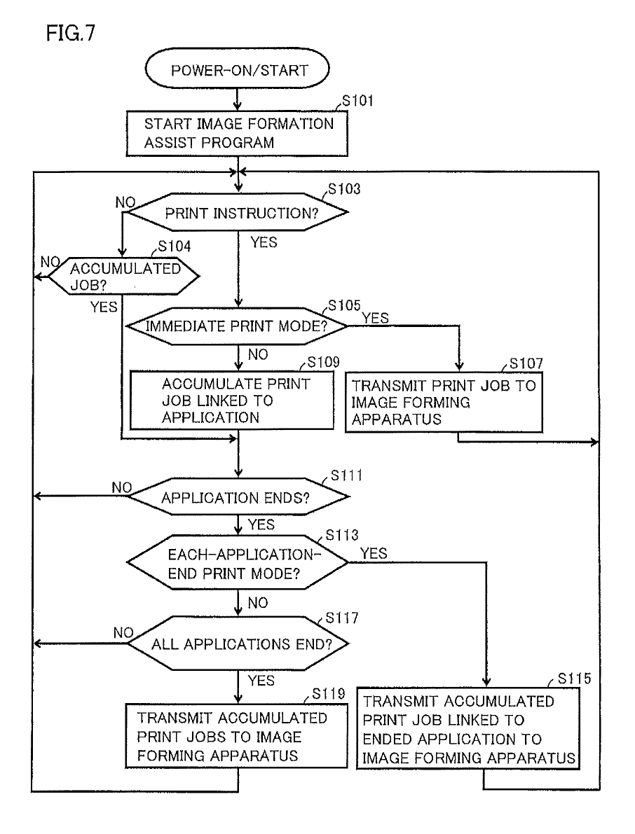

Referring to FIG. 7, description will be given on a flow of processing in PC 104 according to the first embodiment. The processing shown in the flowchart of FIG. 7 starts when PC 104 is powered on. This processing is implemented by CPU 301 that controls various portions in FIG. 4 by reading and executing a control program for controlling PC 104.

Referring to FIG. 7, when the processing starts in response to the power-on, CPU 301 reads and activates image formation assist program 3021 in HDD 302 in a step S101. Then, CPU 301 waits for the input of the print instruction from input unit 401.

When input unit 401 accepts the input of the print instruction from the application (YES in step S103), first determining unit 403 refers to first storage unit 405, and determines the print mode that is set.

When the set print mode is the “immediate print mode” (YES in step S105), managing unit 407 determines that the print processing for the print job in question is to be executed now. Accordingly, sending unit 4075 transmits the produced print job to output unit 415 in a step S107. The print job is transmitted from communication I/F unit 304 over network 102 to image forming apparatus 103. Thereby, image forming apparatus 103 performs the print processing for the print job according to the timing of accept of the print instruction in step S103.

When the set print mode is not the “immediate print mode” (NO in step S105), managing unit 407 determines that the timing for executing the print processing for the print job in question is different from the timing of production of the print job. In a step S109, therefore, storing unit 4073 performs the processing of storing the produced print job in second storage unit 413 with the link established to the application that is the output source of the print instruction. Thereby, the print job is not executed and is accumulated.

Even when input unit 401 does not accept the print instruction from the application, second storage unit 413 has already stored a job in some cases (NO in step S103 and YES in step S104). In these cases, the subsequent processing will likewise be performed.

Second determining unit 411 monitors the application that is running in CPU 301, and thereby determines whether the application ends or not. When CPU 301 ends the application that is the output source of the above print instruction (YES in step S111), and the currently set print mode is the “each-application-end print mode” (YES in step S113), managing unit 407 determines based on the foregoing database that the print processing is to be executed now for the print job stored in second storage unit 413 and linked to the application that is the output source of the above print instruction. Therefore, even in the case where there is no input of the print job that is stored in second storage unit 413 with the link established to the application in step S109 and/or there is no input of the print instruction from the application to input unit 401, sending unit 4075 reads, in a step S115, the print job stored in second storage unit 413 and provides it to output unit 415, when second storage unit 413 has already stored the job. The print job is transmitted from communication I/F unit 304 over network 102 to image forming apparatus 103. According to the timing of the ending of the application, image forming apparatus 103 thereby performs the print processing for the print job that has been accumulated with the link established to the application.

When the print mode that is set is the “all-application-end print mode” (NO in step S113), second determining unit 411 further monitors the application that is running in CPU 301, and thereby determines whether all the applications has ended or not. When CPU 301 has ended all the applications including the application that is the output source of the above print instruction (YES in step S117), managing unit 407 determines that the print processing for all the print jobs stored in second storage unit 413 is to be executed now. Therefore, even in the case where there is no input of all the print jobs that are stored in second storage unit 413 in step S109 and/or there is no input of the print instruction from the application to input unit 401, sending unit 4075 reads, in step S119, all the jobs stored in second storage unit 413 and provides them to output unit 415, when second storage unit 413 has already stored the job. The print job is transmitted from communication I/F unit 304 over network 102 to image forming apparatus 103. According to the timing of the ending of all the applications, image forming apparatus 103 thereby performs the print processing for all the print jobs that have been accumulated.

When PC 104 performs the above processing, image forming system 101 according to the first embodiment operates to perform the print processing by image forming apparatus 103 according to the print mode that is set by PC 104. Thus, when the user wants to obtain immediately a printout, the user sets the “immediate print mode” in PC 104 so that image forming apparatus 103 produces the printout by performing the print processing according to the timing of the print instruction. Thereby, the user can immediately obtain the printout after the print instruction, and the user's convenience is not impaired.

For example, a certain user who is browsing web sites performs the print instruction for each of displayed web pages, and will collectively prints them for confirmation after the end of the web browsing. In this case, the user can set the “each-application-end print mode” in PC 104. Thereby, the print jobs produced according to the print instructions are accumulated, and image forming apparatus 103 will collectively perform the print processing to produce the printouts after PC 104 ends the execution of the web browsing application. This manner can reduce the number of times of the start preparing operation and end preparing operation for the print operation in image forming apparatus 103, and thereby can suppress the power consumption of image forming apparatus 103. Further, for executing the print processing according to the above timing, the user is merely required to set the print mode according to predetermined timing, e.g., at the startup of PC 104, and is not required to set individually the print mode for each print instruction. Therefore, the power consumption of image forming apparatus 103 can be suppressed without impairing the user's convenience.

In another manner, a user who is simultaneously running a plurality of applications may perform the print instruction for several applications, and will confirm the printouts when all the processing ends. In this case, the user sets the “all-application-end print mode” in PC 104. Thereby, all the print jobs produced according to the print instructions are accumulated, and image forming apparatus 103 will collectively perform the print processing to produce the printouts when PC 104 ends the running of all the applications. This manner can further reduce the number of times of the start preparing operation and end preparing operation for the print operation in image forming apparatus 103, and thereby can suppress the power consumption of image forming apparatus 103. Further, for executing the print processing according to the above timing, the user is merely required to set the print mode according to predetermined timing, e.g., at the startup of PC 104, and is not required to set individually the print mode for each print instruction. Therefore, the power consumption of image forming apparatus 103 can be suppressed without impairing the user's convenience.

[Modification]

In the first embodiment, the three kinds of, i.e., first to third print modes are prepared as the print modes, and can be selected and set in advance. However, the kinds of print modes are not restricted to the above three. It is possible to employ only two kinds of print modes that are the second print mode, i.e., “each-application-end print mode” and the third mode, i.e., the “all-application-end print mode”. In this case, one of these print modes is set through a set screen similar to that shown in FIG. 5, and is stored in first storage unit 405. This structure can reduce the user's setting operations, and the power consumption of image forming apparatus 103 can be suppressed without impairing the user's convenience.

Further, the kinds of the print modes are not restricted to the foregoing three, and only the second print mode, i.e., “each-application-end print mode” or the third mode, i.e., the “all-application-end print mode” may be employed. In this case, the function of PC 104 shown in FIG. 4 may not include first determining unit 403 and first storage unit 405, and storing unit 4073 stores all the produced print jobs in second storage unit 413. Further, when the print mode is the “all-application-end print mode”, storing unit 4073 is not required to store the print job with the link established to the application that is the sender of the print instruction as described before. In this case, sending unit 4075 reads the print job from second storage unit 413 according to one of the above prescribed timing settings, and sends it to output unit 415. In this case, therefore, the processing of PC 104 does not perform the determination by managing unit 407 represented in steps S105 and S113, and accumulates all the print jobs in step S109 without performing the sending of the print jobs for the immediate print in step S107. In this case, PC 104 performs the transmission of the print job in a step S115 or S119 according to the print mode already set. This configuration can automatically suppress the power consumption of image forming apparatus 103 without putting a load of setting operation on the user.

### Second Embodiment

In a second embodiment, as shown in FIG. 2, ROM 202 stores an image formation assist program 2021, and image forming apparatus 103 performs the print processing for the print job provided from PC 104 according to the predetermined timing.

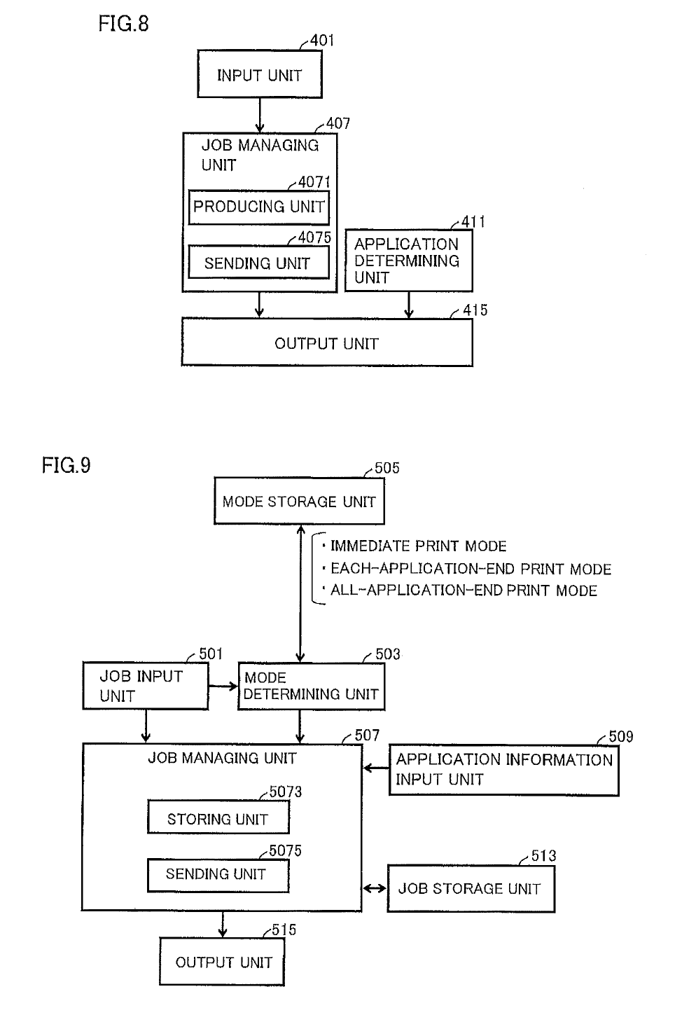

The function of PC 104 according to the second embodiment shown in FIG. 8 is likewise implemented primarily by CPU 301 reading and executing image formation assist program 3021 stored in HDD 302. A part of such function may be a function formed in CPU 301. Also, a part of such function may be formed of a hardware structure.

Referring to FIG. 8, the above function of PC 104 includes an application information output unit 417 instead of first determining unit 403, first storage unit 405 and second storage unit 413 included in the function of PC 104 according to the first embodiment shown in FIG. 4. Further, managing unit 407 includes only producing unit 4071 and sending unit 4075.

In the second embodiment, sending unit 4075 of managing unit 407 sends all the print jobs produced by producing unit 4071 to output unit 415 according to the timing of production of the print jobs. In the sending operation, sending unit 4075 adds the information that is stored in advance for identifying PC 104 on image forming system 101 to the print job, and sends it to output unit 415. The information for identifying PC 104 on image forming system 101 is, e.g., an IP address on network 102 and others. It may be a preassigned identification number or the like. Output unit 415 performs the processing for providing the print job to image forming apparatus 103 through communication I/F unit 304. In the above description, sending unit 4075 adds the identification information to the print job. However, output unit 415 may be configured to store the identification information and add it when the print job is sent to image forming apparatus 103.

Second determining unit 411 performs the determination about the ending of execution of the application that is the output source of the print instruction, and/or about the ending of execution of all the applications, and provides a result of the determination to output unit 415. Output unit 415 performs the processing for providing, as the application information, the information indicating the determination result of second determining unit 411 to image forming apparatus 103 through communication I/F unit 304.

The function of image forming apparatus 103 according to the second embodiment shown in FIG. 9 is implemented primarily by CPU 201 reading and executing image formation assist program 2021 stored in ROM 202. A part of such function may be a function formed in CPU 201. Also, a part of such function may be formed of a hardware structure.

Referring to FIG. 9, the function of image forming apparatus 103 includes a first input unit 501, a first determining unit 503, a first storage unit 505, a managing unit 507, a second input unit 509, a second storage unit 513 and an output unit 515. Managing unit 507 includes a storing unit 5073 and a sending unit 5075. The functions bearing the same names as those of PC 104 shown in FIG. 4 are substantially the same as those of PC 104 in the first embodiment described with reference to FIG. 4.

In image forming apparatus 103 according to the second embodiment, first input unit 501 receives the print job transmitted from PC 104 through communication I/F unit 204, and accepts it input. The received print job enters managing unit 507. Second input unit 509 receives the above application information sent from PC 104 through communication I/F unit 204, and accepts the input thereof. The received application information is provided to managing unit 507.

The application information accepted by second input unit 509 is transmitted from PC 104, and is a result of the determination performed by PC 104 about the ending of execution of the application that is the output source of the print instruction relating to the print job transmitted from image forming apparatus 103, and/or about the ending of the execution of all the applications.

When first determining unit 503 determines that the mode not immediately executing the print processing in response to the print instruction is set, and thus determines that the second mode, i.e., “each-application-end print mode” or the third mode, i.e., the “all-application-end print mode” managing unit 507 is currently set, managing unit 507 determines that the timing for performing the print processing for the print job is different from that of input of the print job. In this case, storing unit 5073 performs the processing for storing the print job provided from first input unit 501 in second storage unit 513.

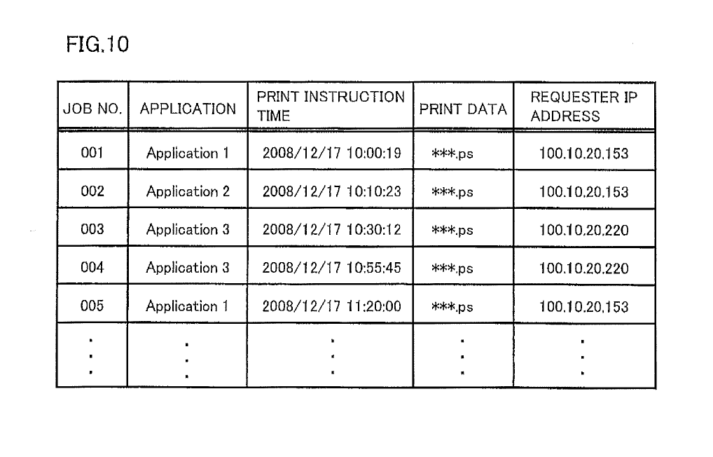

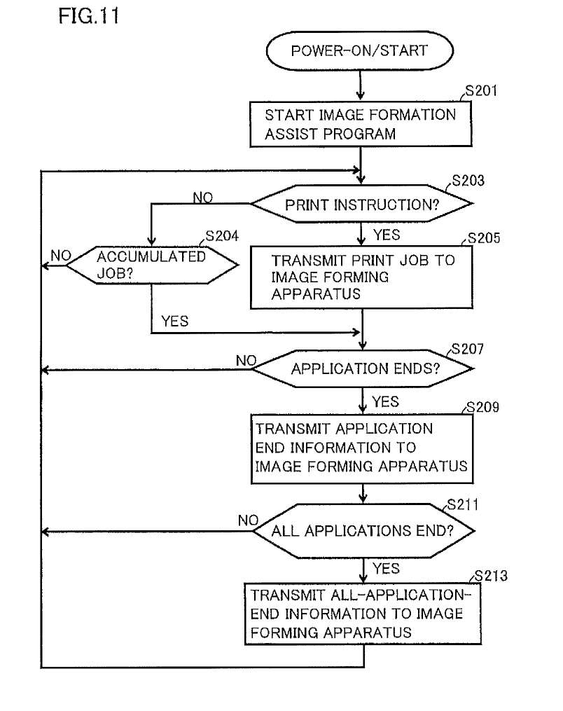

Referring to FIG. 10, storing unit 5073 of image forming apparatus 103 stores, as a database, the print job that is linked to the information shown in FIG. 6 as well as the information that is sent from PC 104 and can identify PC 104 on image forming system 101. In the example shown in FIG. 10, second storage unit 513 has stored the print jobs transmitted from respective PCs 104A and 104B belonging to image forming system 101, and an IP address is linked to each print job as the identification information of the PC (requester) that transmitted the print job. The identification information may be information other than the IP address, provided that it can identify PC 104. In the example in FIG. 10, the print job is linked to the print target data that is the data itself. Similarly to FIG. 6, however, it may be linked to information that indicates the storage location of the data.

When first determining unit 503 determines that the current mode sets immediately executes the print processing in response to the print instruction, and thus determines that the “immediate print mode” that is the first print mode is current set, managing unit 507 determines that the print processing for the print job is to be executed now. In this case, sending unit 5075 sends the print job provided through first input unit 501 to output unit 515.

When first determining unit 503 determines that the “each-application-end print mode” that is the second print mode is set, and the application information provided through second input unit 509 is a result of the determination representing the ending of execution of the application that is the output source of the print instruction, managing unit 507 determines that the print processing for the print job that is stored with the link established to the sender of the application information and the ended application is to be executed now. In this case, sending unit 5075 reads, from second storage unit 513, the stored print job linked to the application and PC 104 that is the sender of the application information, and sends it to output unit 515.

When first determining unit 503 determines that the “all-application-end print mode” that is the third print mode is set, and the application information provided through second input unit 509 is a result of the determination representing the ending of execution of all the applications, managing unit 507 determines that all the print jobs stored in second storage unit 513 with the link established to the sender of the application information is to be executed now. In this case, sending unit 5075 reads all the print jobs stored in second storage unit 513 with the link established to the sender of the application information, and sends them to output unit 515.

Output unit 515 performs the processing for providing the print job to image forming unit 205 together with the print instruction.

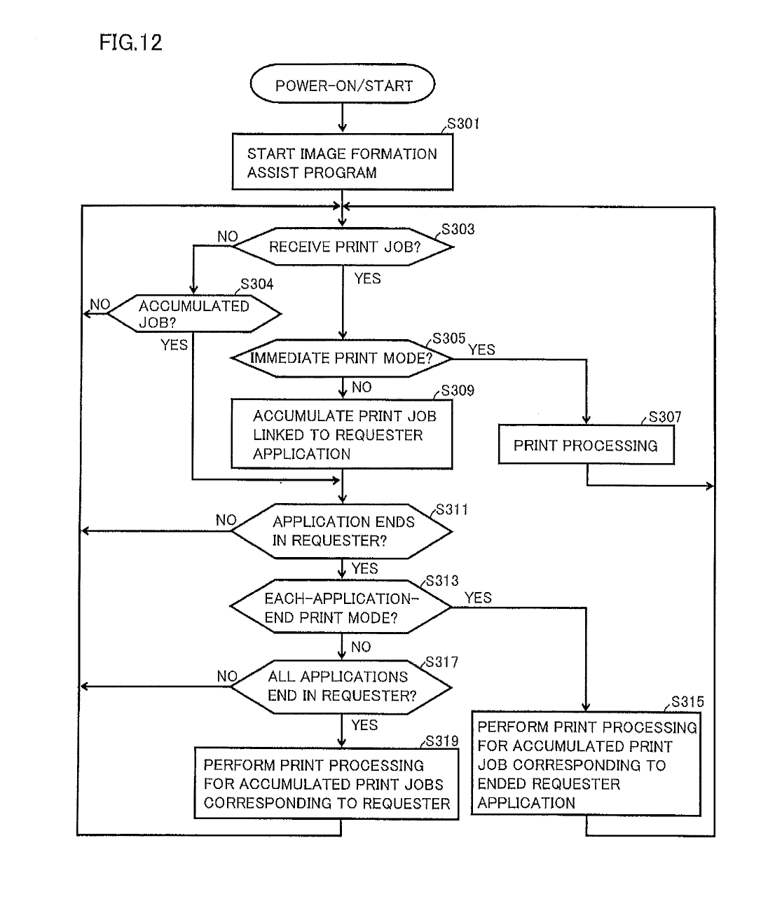

Referring to FIGS. 11 and 12, description will be given on the processing in image forming system 101 according to the second embodiment. FIG. 11 shows the processing in PC 104, and FIG. 12 shows the processing in image forming apparatus 103. Each processing starts when each device or apparatus is turned on. CPUs 201 and 301 read and execute the respective control programs to control various portions shown in FIGS. 8 and 9 so that the processing is implemented.

Referring to FIG. 11, when PC 104 is powered on to start the processing, CPU 301 reads and starts image formation assist program 3021 in HDD 302 in a step S201. Thereafter, CPU 301 waits for input of the print instruction from input unit 401.

When input unit 401 accepts the input of the print instruction from the application (YES in step S203), sending unit 4075 sends the produced print job to output unit 415 in a step S205. The print job is transmitted from communication I/F unit 304 over network 102 to image forming apparatus 103. Even in the case where input unit 401 does not receive the print instruction from the application, the subsequent processing will likewise be performed when second storage unit 413 has already stored the job (NO in step S203 and YES in step S204).

Second determining unit 411 monitors the application that is running in CPU 301, and performs the determination about the ending of the application. When the application that is the output source of the above print instruction ends in CPU 301 (YES in step S207), second determining unit 411 sends the determination result to that effect to output unit 415. In a step S209, output unit 415 transmits the determination result representing the ending of the application that is the output source of the print instruction to image forming apparatus 103 through communication I/F unit 304 and network 102.

Further, second determining unit 411 monitors the application that is running in CPU 301, and thereby performs the determination about the ending of all the applications. When all the applications including the application that is the output source of the above print instruction end in CPU 301 (YES in step S211), second determining unit 411 sends the determination result to that effect to output unit 415. In a step S213, output unit 415 transmits the determination result representing the ending of all the applications to image forming apparatus 103 through communication I/F unit 304 and network 102.

Referring to FIG. 12, when image forming apparatus 103 is powered on to start the processing, CPU 201 reads and activates image formation assist program 2021 in a step S301. Thereafter, CPU 201 waits for the input of the print job from first input unit 501.

When communication I/F unit 204 receives the print job transmitted from PC 104 in step S205 and accepts the input thereof (YES in step S303), first determining unit 503 determines the print mode that is currently set, with reference to first storage unit 505.

When the set print mode is the “immediate print mode” (YES in step S305), managing unit 507 determines that the print processing for the print job is to be executed now. Therefore, sending unit 5075 sends the print job received in step S303 to output unit 515 in a step S307. The print job is transmitted to image forming unit 205. Thereby, image forming unit 205 performs the print processing for the print job according to the timing of reception in step S303.

When the set print mode is not the “immediate print mode” (NO in step S305), managing unit 507 determines that the timing for executing the print processing for the print job is different from the timing of input of the print job. In a step S309, therefore, storing unit 5073 performs the processing of storing the input print job in second storage unit 513 with the link established to the application that is the output source of the print instruction and PC 104 that is the sender of the print job. Thereby, the print job is accumulated without printing.

Even when the print job is not received from PC 104, second storage unit 413 has already stored the job with the link established to the application that is the output source of the print instruction and PC 104 that is the sender of the print job in some cases (NO in step S303 and YES in S304). In these cases, the subsequent processing will likewise be performed.

Managing unit 507 waits for the input of the application information from second input unit 509. When the input application information is provided from PC 104, i.e., the sender of the above print job, and represents the determination result that the application that is the output source of the print instruction ends (YES in step S311) and the set print mode is the “each-application-end print mode” (YES in step S313), managing unit 507 determines that the print processing is to be executed now for the print job that is stored in second storage unit 513 with the link established to the PC, i.e., the sender of the application information and the link established to the ended application. Accordingly, in step S315, sending unit 5075 reads the stored print job from second storage unit 513 and sends it to output unit 515 when second storage unit 413 has already stored the print job linked to the PC and the application described above, even if it does not receive the print job that is stored in second storage unit 513 with the link established to the PC and the application in step S309 and/or it does not receive the print job from PC 104. The print job is transmitted to image forming unit 205. Thereby, image forming unit 205 performs the print processing for the print job already accumulated and linked to PC 104 and the application according to the timing of the ending of the application in PC 104.

When the set print mode is the “all-application-end print mode” (NO in step S313), managing unit 507 waits for the input of the application information provided from second input unit 509 and representing the determination result that all the applications end in PC 104 that is the sender of the above print job. When this application information is input, i.e., when all the applications end in PC 104 that is the sender of the above print job (YES in step S317), managing unit 507 determines that the print processing for all the print jobs stored in second storing unit 513 and linked to PC 104 that is the sender of the print job is to be executed now. Accordingly, in step S319, sending unit 5075 reads all the stored print jobs from second storage unit 513 and sends them to output unit 515 when second storage unit 413 has already stored the print job linked to the PC, even if it does not receive the print job that is stored in second storage unit 513 with the link established to PC 104 in step S309 and/or it does not receive the print job from PC 104. The print job is transmitted to image forming unit 205. Thereby, image forming unit 205 performs the print processing for the accumulated print jobs linked to PC 104 according to the timing of the ending of all the applications in PC 104.

When PC 104 and image forming apparatus 103 perform the above processing, image forming system 101 according to the second embodiment performs the print processing for the print job of which printing is requested by PC 104 according to the print mode set in image forming apparatus 103. Thereby, the power consumption of image forming apparatus 103 can be suppressed without impairing the user's convenience similarly to the first embodiment.

[Modification]

Image forming system 101 according to the second embodiment may employ the forms of the print modes similar to those in the modification of the first embodiment.

In the second embodiment, the print mode set in image forming apparatus 103 is applied to the print jobs provided from all PCs 104. However, image forming apparatus 103 may individually set the print mode for each PC 104. In this case, first storage unit 505 stores the print mode for each PC 104. In step S305 already described, first determining unit 503 likewise reads, from first storage unit 505, the print mode corresponding to PC 104 that is the sender of the print job linked to the print mode received in step S303, and specifically determines the print mode. This manner can individually set the timing for obtaining the printout corresponding to each user, and therefore can improve the user's convenience.

In the above example, when the print job is to be in PC 104, the link is established among information (application) specifying the application that is the output source of the print instruction of the print target data, time information (print instruction time) about the time when the print instruction is issued, information (print linked item) indicating the storage location of the print target data, and information (requester IP address) identifying PC 104. When image forming apparatus 103 receives the print job from PC 104, it may specify PC 104 that transmitted the print job and requested the print processing, and thereby the linking of the above information identifying PC 104 may be performed on the side of image forming apparatus 103. Likewise, image forming apparatus 103 may analyze the print job provided from PC 104 to specify the application, and thereby the linking of the information (application) specifying the application that is the output source of the print instruction may be performed on the side of image forming apparatus 103.

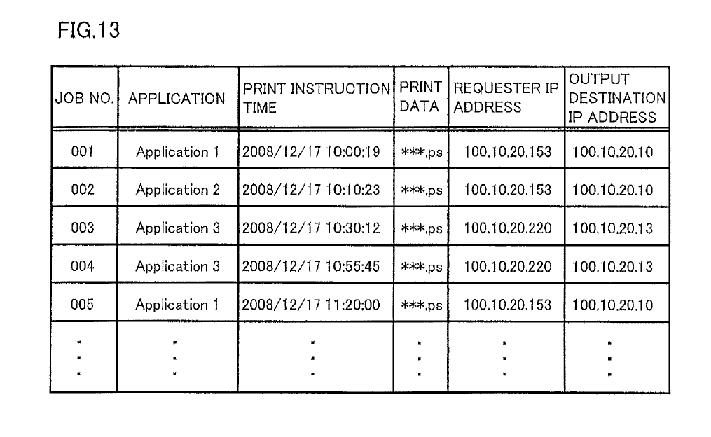

Further, when image forming system 101 shown in FIG. 1 includes print server 105, print server 105 may perform the processing that is performed in image forming apparatus 103 according to the second embodiment. In this case, print server 105 has stored the image formation assist program in storage means (not shown), and can execute this program to implement substantially the same function as that shown in FIG. 9. When print server 105 is employed, the print job is transmitted from PC 104 to print server 105, and the print job is transmitted together with the print instruction to image forming apparatus 103 to perform the print processing according to the timing determined by print server 105. Print server 105 executes the processing that is performed in image forming apparatus 103 according to the second embodiment shown in FIG. 21. Thus, according to the print mode that is already set in print server 105, print server 105 performs the determination to transmit immediately the print job received from PC 104 and perform the print processing, or to store temporarily it in the job storage unit for performing the print processing by transmitting the print job to image forming apparatus 103 in response to the ending of the application having issued the print instruction in the requester, i.e., PC 104, or in response to the ending of all the applications. As shown in FIG. 13, print server 105 stores, as the print jobs transmitted from respective PCs 104, the print target data items in the job storage unit with a link established to various information items shown in FIG. 10 as well as the information (output destination IP address) identifying image forming apparatus 103 performing the print processing. The information for identifying image forming apparatus 103 may be the IP address or other information that can identify image forming apparatus 103, similarly to the information (requester IP address) that can identify PC 104. Similarly to the second embodiment, this structure can suppress the power consumption in image forming apparatus 103 without impairing the user's convenience.

Further, the foregoing image formation assist program itself may be provided. This program may be provided as a program product by recording it on a computer-readable recording medium such as a flexible disk, CD-ROM (Compact Disk-Read Only Memory), ROM, RAM and memory card that are included or attached to a computer. Also, the program may be provided by recording it on a recording medium such as an internal hard disk of a computer. Further, the program may be provided by downloading over the network.

The program may be formed of program modules that are provided as a part of an Operating System (OS) of the computer, and may be configured to execute the processing by calling required modules in a predetermined order according to predetermined timing. In this case, the program itself does not include the above module, and cooperates with the OS to execute the processing. The foregoing program includes this kind of program not including the module.

The program may be providing by incorporating it into a part of a different program such as a printer driver. In this case, the program itself does not include the module included in the above different program, and cooperates with the different program to execute the processing similarly to the above. The foregoing program includes this kind of program incorporated into the different program.

The provided program product is installed in a program storing unit such as a hard disk for execution. The program product includes the program itself and the recording medium bearing the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming system for performing print processing in an image forming apparatus based on an operation in an information processing device, comprising:
a producing unit for producing a print job based on an operation in said information processing device;
a storing unit for storing said print job in a storage device;
a sensing unit for sensing ending of an application in said information processing device; and
a print processing unit for performing print processing in said image forming apparatus for said print job stored in said storing unit when said sensing unit senses the ending of said application.

2. The image forming system according to claim 1, wherein
said information processing device includes said producing unit, said storing unit and said sensing unit, and said information processing device further includes
a transmitting unit for reading said print job stored in said storage device and transmitting said print job to said image forming apparatus when said sensing unit senses the ending of said application,
said image forming apparatus includes said print processing unit, and said image forming apparatus further includes
a receiving unit for receiving said print job transmitted from said information processing device, wherein
said print processing unit executes the print processing for said print job when said receiving unit receives said print job from said information processing device.

3. The image forming system according to claim 2, wherein
said storing unit stores said print job in said storage device with a link established to the application used for producing said print job, and
when said sensing unit senses the ending, in said information processing device, of the application used for producing said print job, said print processing unit executes the print processing for said print job stored in said storage device with the link established to said application.

4. The image forming system according to claim 2, wherein
when said sensing unit senses the ending, in said information processing device, of all the applications capable of producing the print jobs, said print processing unit executes the print processing for all the print jobs stored in said storage device.

5. The image forming system according to claim 2, wherein
said information processing device further includes a selection unit for selecting the print mode to be executed from among first, second and third print modes, wherein
said first print mode is for immediately starting the print processing in response to the print job indicated by the print instruction, said second print mode is for executing the print processing for the print job stored in said storage device with a link established to said application when the ending of the application used for producing the print job is sensed, and said third print mode is for executing the print processing for all the print jobs stored in said storage device when the ending of all the applications capable of producing the print jobs is sensed, and
said transmitting unit transmits said print job to said image forming apparatus according to the timing of said print processing defined in said selected print mode.

6. The image forming system according to claim 1, wherein
said information processing device includes said producing unit and said sensing unit, and said information processing device further includes:
a first transmitting unit for transmitting said produced print job to said image forming apparatus, and
a second transmitting unit for transmitting, to said image forming apparatus, information to the effect that said sensing unit sensed the ending of said application;
said image forming apparatus includes said storing unit and said print processing unit, and said image forming apparatus further includes
a first receiving unit for receiving said print job transmitted from said information processing device, and
a second receiving unit for receiving the information transmitted from said information processing device and indicating that said information processing device sensed the ending of said application, wherein
said storing unit stores said print job received by said first receiving unit in said storage device; and
said print processing unit executes the print processing for said print job when said second receiving unit receives, from said information processing device, the information to the effect that the ending of said application was sensed.

7. The image forming system according to claim 6, wherein
said storing unit stores said print job in said storage device with a link established to the application used for producing said print job, and
when said second receiving unit receives the information to the effect that the ending of the application used for producing said print job is sensed, said print processing unit executes the print processing for said print job stored in said storage device with the link established to said application.

8. The image forming system according to claim 7, wherein
said storing unit further stores said print job in said storage device with a link established to said information processing device.

9. The image forming system according to claim 6, wherein
when said second receiving unit receives the information indicating that the ending of all the applications capable of producing the print jobs was sensed, said print processing unit executes said print processing for all the print jobs stored in said storage device.

10. The image forming systems according to claim 6, wherein
said image forming apparatus further includes a selection unit for selecting a print mode to be executed from among first, second and third print modes, wherein
said first print mode is for immediately starting the print processing in response to the print job indicated by the print instruction, said second print mode is for executing the print processing for the print job stored in said storage device with a link established to said application when the ending of the application used for producing the print job is sensed, and said third print mode is for executing the print processing for all the print jobs stored in said storage device when the ending of all the applications capable of producing the print jobs is sensed, and
said print processing unit executes the print processing for said print job according to the timing of said print processing defined in said selected print mode.

11. An information processing device being communicably connectable to an image forming apparatus, comprising
a storage device; and
a processor, wherein
said processor is configured:
i) to produce a print job by an application;
ii) to store said print job in said storage device;
iii) to sense ending of said application; and
iv) to read said print job stored in said storage device and providing a print instruction for said print job to said image forming apparatus when the ending of said application is sensed.

12. The information processing device according to claim 11, wherein
when storing said print job in said storage device, said processor stores said print job with a link established to said application, and
when providing said print instruction, said processor reads said stored print job linked to said application from said storage device and provides the print instruction for said print job to said image forming apparatus when the ending of the application used for producing said print job is sensed in the processing of sensing the ending of said application.

13. The information processing device according to claim 11, wherein
when the ending of all the applications capable of producing the print jobs is sensed in the processing of sensing the ending of said application, said processor performs the processing of providing said print instruction by reading all the print jobs stored in said storage device and providing the print instruction for said print jobs to said image forming apparatus.

14. The information processing device according to claim 11, further comprising an input device for accepting input of an instruction for selecting a print mode to be executed from among first, second and third print modes, wherein
said first print mode is for immediately starting the print processing in response to the print job indicated by the print instruction, said second print mode is for executing the print processing for the print job stored in said storage device with a link established to said application when the ending of the application used for producing the print job is sensed, and said third print mode is for executing the print processing for all the print jobs stored in said storage device when the ending of all the applications capable of producing the print jobs is sensed, and
when providing said print instruction, said processor provides the print instruction for said print job to said image forming apparatus according to the timing of said print processing defined in said selected print mode.

15. A print server comprising a communication device for connection to an information processing device and an image forming apparatus capable of producing a print job by an application, and a processor, wherein
said processor is configured
i) to sense ending of said application in said information processing device, and
ii) to provide a print instruction for said print job produced by said application to said image forming apparatus when the ending of said application is sensed.

16. The print server according to claim 15, further comprising:
a storage device for storing said print job with a link established to the application used for producing said print job and said information processing device, and
when the ending of said application in said information processing device is sensed, said processor performs the processing of providing said print instruction by reading said stored print job linked to said application and said information processing device from said storage device and providing the print instruction for said print job to said image forming apparatus.

17. The print server according to claim 15, further comprising:
a storage device for storing the print job with a link established to said information processing device, wherein
when the ending of all the applications cable of producing the print job is sensed in said information processing device, said processor performs the processing of outputting said print instruction by reading all the print jobs stored in said storage device with the link established to said information processing device and providing the print instruction for said print jobs to said image forming apparatus.

18. The print server according to claim 15, further comprising:
a storage device for storing the print job with a link established to said information processing device, wherein
when the ending of said application is sensed in said information processing device, said processor performs the processing of providing said print instruction by reading said print job stored in said storage device with the link established to said information processing device and providing the print instruction for said print job to said image forming apparatus.

19. The print server according to claim 15, further comprising an input device for accepting input of an instruction for selecting a print mode to be executed from among first, second and third print modes, wherein
said first print mode is for immediately starting the print processing in response to the print job indicated by the print instruction, said second print mode is for executing the print processing for the print job stored in said storage device with a link established to said application when the ending of the application used for producing the print job is sensed, and said third print mode is for executing the print processing for all the print jobs stored in said storage device when the ending of all the applications capable of producing the print jobs is sensed; and
in the processing of providing said print instruction, said processor provides the print instruction for said print job to said image forming apparatus according to the timing of said print processing defined in said selected print mode.

20. An image forming apparatus comprising:
a receiving unit for receiving a print job produced by an application from an information processing device;
a storing unit for storing said print job in a storage device;
a sensing unit for sensing ending of said application in said information processing device; and
a print processing unit for reading said print job stored in said storage device and executing print processing when said sensing unit senses the ending of said application.

21. The image forming apparatus according to claim 20, wherein
said storing unit stores said print job in said storage device with a link established to the application used for producing said print job, and
said print processing unit executes the print processing by reading said stored print job linked to said application form said storage device when said sensing unit senses the ending, in said information processing device, of the application used for producing said print job.

22. The image forming apparatus according to claim 21, wherein
said storing unit further stores said print job in said storage device with a link established to said information processing device.

23. The image forming apparatus according to claim 20, wherein
said print processing unit executes the print processing for all the print jobs stored in said storage device when said sensing unit senses the ending, in said information processing device, of all the applications capable of producing the print jobs.

24. The image forming apparatus according to claim 20, further comprising:
a selection unit for selecting a print mode to be executed from among first, second and third print modes, wherein
said first print mode is for immediately starting the print processing in response to the print job indicated by the print instruction, said second print mode is for executing the print processing for the print job stored in said storage device with a link established to said application when the ending of the application used for producing the print job is sensed, and said third print mode is for executing the print processing for all the print jobs stored in said storage device when the ending of all the applications capable of producing the print jobs is sensed, and
said print processing unit executes the print processing for said print job according to the timing of said print processing defined in said selected print mode.

25. A computer-readable medium recording an image formation assist program for causing a computer to execute processing of printing, by an image forming apparatus, a print job produced in an information processing device, wherein
said program causes said computer to execute the steps of:
sensing ending of the application having produced said print job,
obtaining said print job stored in said storage device based on the sensing of the ending of said application, and
instructing said image forming apparatus to print said obtained print job.

26. A print control method for controlling printing by an image forming apparatus for a print job produced in an information processing device, comprising the steps of:
sensing ending of the application having produced said print job,
obtaining said print job stored in said storage device based on the sensing of the ending of said application, and
instructing said image forming apparatus to print said obtained print job.
